(19) United States
(12) Patent Application Publication
(10) Pub. No.: US 2025/0310756 A1
(43) Pub. Date: Oct. 2, 2025

(54) AI COMPUTING POWER REPORTING METHOD, TERMINAL, AND NETWORK-SIDE DEVICE

(71) Applicant: VIVO MOBILE COMMUNICATION CO., LTD., Dongguan (CN)

(72) Inventors: Ang YANG, Dongguan (CN); Peng SUN, Dongguan (CN)

(21) Appl. No.: 19/236,151

(22) Filed: Jun. 12, 2025

Related U.S. Application Data
(63) Continuation of application No. PCT/CN2023/138240, filed on Dec. 12, 2023.

(30) Foreign Application Priority Data
Dec. 15, 2022 (CN) 202211616288.6

(51) Int. Cl. H04W 8/24

(52) U.S. Cl. CPC H04W 8/24

(57) ABSTRACT

Disclosed are an AI computing power reporting method, a terminal, and a network-side device, relating to the technical field of communications. A terminal obtains first AI computing power information. The terminal sends the first AI computing power information to a network-side device. The first AI computing power information is used for indicating at least one of the following: current remaining AI model computing resources of the terminal; current available AI model computing resources of the terminal; all AI model computing resources of the terminal; or all AI model computing resources of the terminal available for wireless communication.

### CROSS-REFERENCE TO RELATED APPLICATIONS

This application is a bypass continuation application of International Application No. PCT/CN2023/138240, filed on Dec. 12, 2023, which claims the benefit of and priority to Chinese Patent Application No. 202211616288.6 filed on Dec. 15, 2022, both of which are incorporated by reference in their entireties herein.

### TECHNICAL FIELD

This application relates to the field of communication technologies and, more particularly, relates to an artificial intelligence (AI) computing power reporting method, a terminal, and a network-side device.

### BACKGROUND

Artificial Intelligence (AI) technology is now widely used across various fields. A key objective for future wireless communication networks is to incorporate artificial intelligence into network infrastructure to achieve substantial improvements in performance metrics, such as throughput, latency, and user capacity.

In the related art, a network side device may instruct a User Equipment (UE) to use a particular AI model.

### SUMMARY

Embodiments of this application provide an AI computing power reporting method, a terminal, and a network-side device.

According to a first aspect, an AI computing power reporting method is provided. The method includes:

A terminal obtains first AI computing power information.

The terminal sends the first AI computing power information to a network-side device.

The first AI computing power information is used for indicating at least one of the following:
current remaining AI model computing resources of the terminal;
current available AI model computing resources of the terminal;
all AI model computing resources of the terminal; or
all AI model computing resources of the terminal available for wireless communication.

According to a second aspect, an AI computing power reporting method is provided. The method includes:

A network-side device receives first AI computing power information sent by a terminal.

The network-side device obtains, based on the first AI computing power information, second AI computing power information corresponding to the terminal. The second AI computing power information is used for indicating remaining AI model computing resources, estimated by the network-side device, of the terminal.

The first AI computing power information is used for indicating at least one of the following:
current remaining AI model computing resources of the terminal;
current available AI model computing resources of the terminal;
all AI model computing resources of the terminal; or
all AI model computing resources of the terminal available for wireless communication.

According to a third aspect, an AI computing power reporting apparatus is provided. The apparatus includes:
a first obtaining module, configured to obtain first AI computing power information; and
a sending module, configured to send the first AI computing power information to a network-side device.

The first AI computing power information is used for indicating at least one of the following:
current remaining AI model computing resources of the terminal;
current available AI model computing resources of the terminal;
all AI model computing resources of the terminal; or
all AI model computing resources of the terminal available for wireless communication.

According to a fourth aspect, an AI computing power reporting apparatus is provided. The apparatus includes:
a receiving module, configured to receive first AI computing power information sent by a terminal; and
a second obtaining module, configured to obtain, based on the first AI computing power information, second AI computing power information corresponding to the terminal. The second AI computing power information is used for indicating remaining AI model computing resources, estimated by the network-side device, of the terminal.

The first AI computing power information is used for indicating at least one of the following:
current remaining AI model computing resources of the terminal;
current available AI model computing resources of the terminal;
all AI model computing resources of the terminal; or
all AI model computing resources of the terminal available for wireless communication.

According to a fifth aspect, a terminal is provided. The terminal includes a processor and a memory. The memory stores a program or instruction executable on the processor. The program or instruction, when executed by the processor, implements the steps of the method according to the first aspect.

According to a sixth aspect, a terminal is provided, including a processor and a communication interface. The processor is configured to obtain first AI computing power information. The communication interface is configured to send the first AI computing power information to a network-side device. The first AI computing power information is used for indicating at least one of the following: current remaining AI model computing resources of the terminal; current available AI model computing resources of the terminal; all AI model computing resources of the terminal; or all AI model computing resources of the terminal available for wireless communication.

According to a seventh aspect, a network-side device is provided. The network-side device includes a processor and a memory. The memory stores a program or instruction executable on the processor. The program or instruction, when executed by the processor, implements the steps of the method according to the second aspect.

According to an eighth aspect, a network-side device is provided, including a processor and a communication interface. The communication interface is configured to receive first AI computing power information sent by a terminal. The processor is configured to obtain, based on the first AI computing power information, second AI computing power information corresponding to the terminal. The second AI computing power information is used for indicating remaining AI model computing resources, estimated by the network-side device, of the terminal. The first AI computing power information is used for indicating at least one of the following: current remaining AI model computing resources of the terminal; current available AI model computing resources of the terminal; all AI model computing resources of the terminal; or all AI model computing resources of the terminal available for wireless communication.

According to a ninth aspect, an AI computing power reporting system is provided, including: a terminal and a network-side device. The terminal may be configured to perform the steps of the method according to the first aspect. The network-side device may be configured to perform the steps of the method according to the second aspect.

According to a tenth aspect, a readable storage medium is provided. The readable storage medium has a program or instruction stored therein. The program or instruction, when executed by a processor, implements the steps of the method according to the first aspect, or implements the steps of the method according to the second aspect.

According to an eleventh aspect, a chip is provided. The chip includes a processor and a communication interface. The communication interface is coupled to the processor. The processor is configured to execute a program or instruction, to implement the method according to the first aspect or implement the method according to the second aspect.

According to a twelfth aspect, a computer program/program product is provided. The computer program/program product is stored in a storage medium. The computer program/program product is executed by at least one processor, to implement the steps of the method according to the first aspect, or implement the steps of the method according to the second aspect.

### BRIEF DESCRIPTION OF THE DRAWINGS

FIG. 1 is a schematic diagram of a wireless communication system to which an embodiment of this application is applicable;

FIG. 2 is a schematic diagram of a structure of a neural network according to an embodiment of this application;

FIG. 3 is a schematic diagram of computing logic of neurons according to an embodiment of this application;

FIG. 4 is a schematic flowchart 1 of an AI computing power reporting method according to an embodiment of this application;

FIG. 5 is a schematic flowchart 2 of an AI computing power reporting method according to an embodiment of this application;

FIG. 6 is a schematic diagram of signaling interaction of an AI computing power reporting method according to an embodiment of this application;

FIG. 7 is a schematic diagram 1 of a structure of an AI computing power reporting apparatus according to an embodiment of this application;

FIG. 8 is a schematic diagram 2 of a structure of an AI computing power reporting apparatus according to an embodiment of this application;

FIG. 9 is a schematic diagram of a structure of a communication device according to an embodiment of this application;

FIG. 10 is a schematic diagram of a structure of a terminal according to an embodiment of this application; and

FIG. 11 is a schematic diagram of a structure of a network-side device according to an embodiment of this application.

### DETAILED DESCRIPTION

Technical solutions in embodiments of this application are clearly and completely described in the following with reference to the accompanying drawings in the embodiments of this application. Apparently, the described embodiments are merely some rather than all the embodiments of this application. Based on the embodiments of this application, all other embodiments derived by those of ordinary skill in the art should fall within the protection scope of this application.

In the specification and claims of this application, terms such as “first” and “second” are configured for distinguishing between similar objects instead of describing a particular order or sequence. It should be understood that terms used in this way may be interchanged under appropriate circumstances, such that the embodiments of this application can be implemented in an order other than those illustrated or described herein. In addition, the objects distinguished by “first” or “second” are usually objects of one class with the number of objects unlimited. For example, there may be one or more first objects. Furthermore, “and/or” in the specification and the claims represents at least one of connected objects, and character “/” generally represents an “or” relationship between associated objects before and after. The term “indication” in the specification and claims of this application may be an explicit indication or an implicit indication. The explicit indication may be understood as that a sending party explicitly notifies a receiving party of an operation to be performed or a request result in a sent indication. The implicit indication may be understood as that the receiving party determines according to an indication sent by the sending party, and determines, according to a determining result, an operation to be performed or a request result.

It is worth pointing out that the technology described in the embodiments of this application is not limited to Long Term Evolution (LTE)/LTE-Advanced (LTE-A) system, and may alternatively be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application are often used interchangeably, and the described technology may be applied to the systems and radio technologies mentioned above, and may alternatively be applied to other systems and radio technologies. The following description describes a New Radio (NR) system for illustration, and NR terminology is used in most of the following descriptions. However, these technologies may alternatively be applied to communication systems other than NR system applications, such as 6th Generation (6G) communication systems.

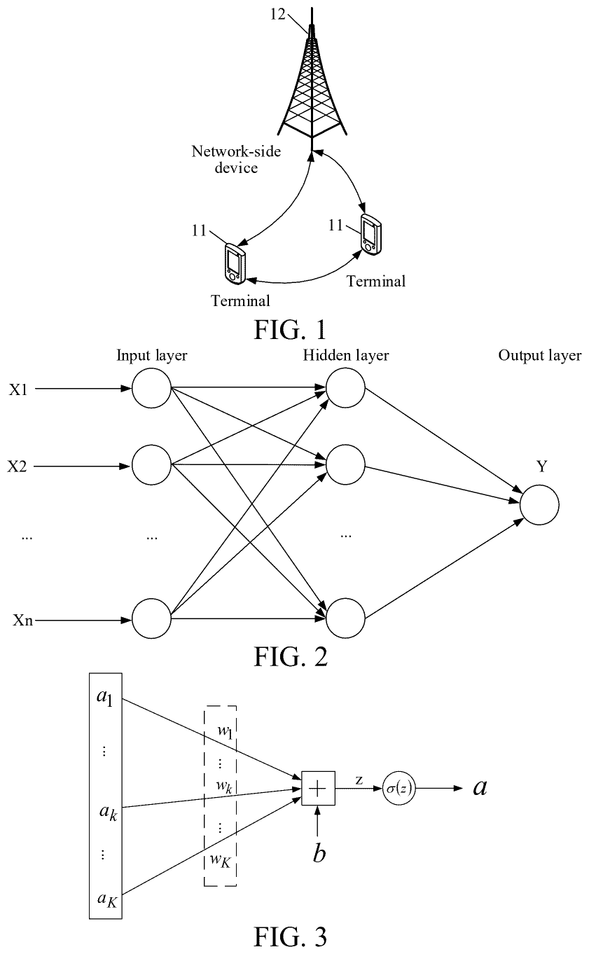

FIG. 1 is a schematic diagram of a wireless communication system to which an embodiment of this application is applicable. The wireless communication system shown in FIG. 1 includes a terminal 11 and a network-side device 12. The terminal 11 may be a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, a vehicle user equipment (VUE), a pedestrian user equipment (PUE), a smart home appliance (home equipment with a wireless communication function, such as a refrigerator, a TV, a washing machine, or furniture), and a terminal-side device such as a game console, a personal computer (PC), an ATM, or a self-service machine. The wearable device includes: a smartwatch, a smart band, a smart headset, smart glasses, smart jewelry (a smart bracelet, a smart chain bracelet, a smart ring, a smart necklace, a smart anklet, a smart ankle chain, or the like), a smart wrist strap, a smart garment, or the like. In addition to the foregoing terminal devices, the terminal 11 may alternatively be a chip within a terminal, such as a modem (Modem) chip or a System on Chip (SoC). It should be noted that a specific type of the terminal 11 is not limited in this embodiment of this application.

The network-side device 12 may include an access network device or a core network device. The access network device may alternatively be referred to as a radio access network device, a Radio Access Network (RAN), a radio access network function, or a radio access network element. The access network device may include a base station, a WLAN access point, a WIFI node, or the like. The base station may be referred to as a Node B, an evolved Node B (eNB), an access point, a Base Transceiver Station (BTS), a radio base station, a radio transceiver, a Basic Service Set (BSS), an Extended Service Set (ESS), a home Node B, a home evolved Node B, a Transmitting Receiving Point (TRP), or some other suitable terms in the field. As long as the same technical effect is achieved, the base station is not limited to a particular technical word. It should be noted that in this embodiment of this application, only a base station in an NR system is described as an example, and a specific type of the base station is not limited. The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), and a Centralized network configuration (CNC), a Network Repository Function (NRF), a Network Exposure Function (NEF), a Local NEF (L-NEF), a Binding Support Function (BSF), an Application Function (AF), a location manage function (LMF), Enhanced Serving Mobile Location Centre (E-SMLC), a network data analytics function (NWDAF), and the like. It should be noted that in this embodiment of this application, only a core network device in the NR system is described as an example, and a specific type of the core network device is not limited.

To facilitate a clearer understanding of the technical solutions provided by embodiments of this application, some related background knowledge is first introduced as follows.

### Artificial Intelligence (AI)

At present, artificial intelligence (AI) is widely used in various fields. It is an important task for a wireless communication network in future to integrate artificial intelligence into the wireless communication network and significantly improve technical indicators such as throughput, delay, and user capacity. There are a plurality of implementations of an AI module, for example, a neural network, a decision tree, a support vector machine, and a Bayes classifier. In this application, the neural network is used as an example for description, but a specific type of the AI module is not limited.

FIG. 2 is a schematic diagram of a structure of a neural network according to an embodiment of this application. As shown in FIG. 2, a neural network includes an input layer, hidden layers, and an output layer, where X₁, X₂, and Xₙ are inputs of the neural network, and Y is an output of the neural network.

The neural network is composed of neurons. FIG. 3 is a schematic diagram of computing logic of neurons according to an embodiment of this application. As shown in FIG. 3, a₁, aₖ, and aₖ are inputs, w₁, wₖ, and w_{K} are weights (multiplicative coefficients), b is a bias (additive coefficient), and σ(z) is an activation function. Common activation functions include Sigmoid, tanh, a linear rectification function (also known as a Rectified Linear Unit (ReLU)), and the like. z may be represented based on the following formula (1):

$$z = {a}_{1} {w}_{1} + … + {a}_{k} {w}_{k} + … + {a}_{K} {w}_{K} + b \qquad ( 1 )$$

Parameters of the neural network are optimized by using a gradient optimization algorithm. The gradient optimization algorithm is a type of algorithm that minimizes or maximizes an objective function (sometimes referred to as a loss function), and the objective function is usually a mathematical combination of a model parameter and data.

For example, given data X and a corresponding label Y, a neural network model f (.) is constructed. After the neural network model is constructed, a predicted output f(x) may be obtained based on the input X, and a difference (f(x)=Y) between a predicted value and a real value may be computed. This is the loss function. The objective of this application is to find proper w, b to minimize the value of the loss function. A smaller loss value indicates that the model is closer to the real situation.

Currently, common optimization algorithms are basically based on an error Back Propagation (BP) algorithm. A basic idea of the BP algorithm is that a learning process includes two processes: signal forward propagation and error back propagation. During forward propagation, an input sample is transmitted from the input layer, processed layer by layer by the hidden layers, and then transmitted to the output layer. If an actual output of the output layer does not match an expected output, error back propagation is performed. The error back propagation is to transmit an output error in a form layer by layer back to the input layer through the hidden layers, and distribute the error to all units at each layer, to obtain an error signal of the units at each layer. This error signal is used as a basis for correcting a weight of each unit. Such a weight adjustment process at each layer of signal forward propagation and error back propagation is performed cyclically. The process of continuously adjusting the weight is a learning and training process of the network. This process continues until errors output by the network are reduced to an acceptable level or until a preset quantity of learning times are reached.

Common optimization algorithms include gradient descent, Stochastic Gradient Descent (SGD), mini-batch gradient descent, momentum, stochastic gradient descent with momentum (Nesterov), adaptive gradient descent (ADAptive GRADient descent, Adagrad), Adadelta, root mean square prop (RMSprop), Adaptive Moment Estimation (Adam), and the like.

During error back propagation, in these optimization algorithms, an error/loss is obtained according to the loss function, a gradient is obtained by calculating a derivative/partial derivative of a current neuron, and adding an effect such as a learning rate and a previous gradient/derivative/partial derivative, and the gradient is transferred to an upper layer.

In the related art, a network side may instruct a UE to use a particular AI model. However, currently, there is no method by which the UE reports a remaining AI computing power, resulting in that the network side cannot accurately estimate the remaining AI computing power of the UE. If the remaining computing power of the UE estimated by the network side is greater than an actual computing power, the network side instructs the UE to use an excessively complex AI model, and consequently, the UE cannot execute the AI model normally. If the remaining computing power of the UE estimated by the network side is lower than the actual computing power, the network side instructs the UE to use an excessively simple AI model, causing a waste of the AI computing power of the UE. To be specific, the network side cannot accurately estimate the remaining AI computing power of the UE. Consequently, utilization of the AI computing power of the UE is relatively low, and performance of a communication system is affected.

In conclusion, in view of the foregoing existing problem, embodiments of this application provide an AI computing power reporting method, a terminal, and a network-side device, to improve performance of a communication system.

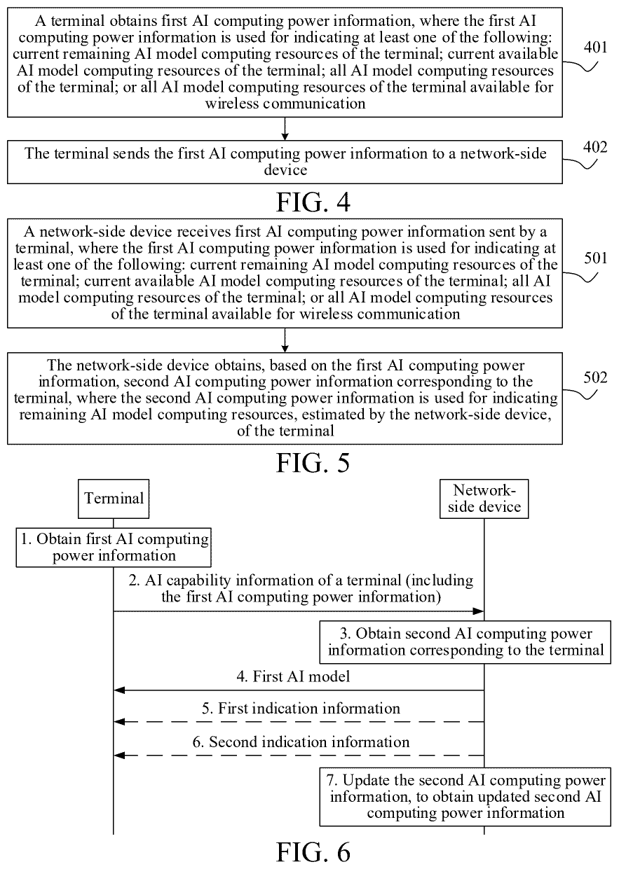

FIG. 4 is a schematic flowchart 1 of an AI computing power reporting method according to an embodiment of this application. As shown in FIG. 4, the method includes step 401 to step 402.

Step 401: A terminal obtains first AI computing power information. The first AI computing power information is used for indicating at least one of the following: current remaining AI model computing resources of the terminal; current available AI model computing resources of the terminal; all AI model computing resources of the terminal; or all AI model computing resources of the terminal available for wireless communication.

It should be noted that this embodiment of this application may be applied to an AI model-based communication scenario. The terminal includes but is not limited to the types of the terminal 11 listed above. The network-side device includes but not limited to the types of the network-side device 12 listed above. This is not limited in this application.

Because the network-side device cannot accurately estimate a remaining AI computing power of the terminal, utilization of the AI computing power of the terminal is relatively low, and performance of a communication system is affected. Therefore, to improve utilization of an AI computing power of the terminal and improve performance of a communication system, in this embodiment, the terminal first needs to obtain first AI computing power information.

Optionally, the first AI computing power information includes M AI units (computing power units), where M is an integer or a decimal. Each AI unit is used for indicating N1 computing resource units, where N1 is a positive integer or a decimal.

The AI unit (computing power unit) is a unit measuring an AI model computing resource. The AI model computing resource is, for example, operations of the AI model.

Optionally, the computing resource unit includes at least one of the following:
a) operations (OP);
b) Trillion operation (TOP);
c) Floating point Operation (FLOP), or Floating point Operations per second (FLOPS);
d) Memory Access Cost (MAC); or
c) multiply-accumulate operations (MACC).

Optionally, a definition of the AI unit satisfies at least one of the following:
a) agreed on in a protocol;
b) defined by the terminal; or
c) configured by the network-side device.

The definition of the AI unit includes: a value of N1, and/or, a type of the computing resource unit.

Step 402: The terminal sends the first AI computing power information to a network-side device.

In this embodiment, the terminal needs to send the obtained first AI computing power information to the network-side device. Correspondingly, after receiving the first AI computing power information, the network-side device needs to obtain, based on the first AI computing power information, second AI computing power information corresponding to the terminal. The second AI computing power information is used for indicating remaining AI model computing resources, estimated by the network-side device, of the terminal.

To be specific, based on the first AI computing power information sent by the terminal, the network-side device may estimate, in real time, the remaining AI model computing resources of the terminal, so as to issue the remaining AI model computing resources of the terminal to the terminal, or indicate an appropriate first AI model to the terminal.

In the AI computing power reporting method provided in this embodiment of this application, a terminal obtains current remaining AI model computing resources available for AI model-related operations, namely first AI computing power information. Then, the first AI computing power information of the terminal is reported to a network-side device, so that the network-side device obtains an accurate terminal remaining computing power. Therefore, the network-side device may perform AI configuration or indication based on the accurate terminal remaining computing power, thereby improving utilization of an AI computing power of the terminal and improving performance of a communication system.

Optionally, that a terminal obtains first AI computing power information may be implemented in any one of the following manners:

Manner 1: The terminal determines the first AI computing power information based on terminal configuration information.

In an actual application, first AI computing power information of the terminal is pre-configured in terminal configuration information, and the terminal may directly obtain the first AI computing power information from the terminal configuration information.

Manner 2: The terminal determines the first AI computing power information based on terminal configuration information and occupied AI computing power information.

In an actual application, in a case that the terminal currently occupies AI computing power information, the occupied AI computing power information may be subtracted from total pre-configured AI computing power information in the terminal configuration information, to obtain first AI computing power information.

Optionally, a quantity of AI units occupied by an AI model is included in model configuration information or association information of the AI model. The quantity of AI units occupied by the AI model is obtained by converting computation complexity of the AI model.

In this embodiment, during AI model registration, AI model configuration, AI model transmission, and AI model transfer, a quantity of AI units occupied by an AI model is included in model configuration information or association information of the AI model. The quantity of AI units occupied by the AI model is obtained by converting computation complexity of the AI model.

For example, one AI unit is used for indicating 5 TOPs, and computation complexity of one AI model is 15 TOPs. Therefore, AI units occupied by the AI model are 15 TOPs divided by 5 TOPs. To be specific, the AI model occupies 3 AI units.

Optionally, the computation complexity of the AI model is N2 computing resource units, where N2 is a positive integer or a decimal.

The computation complexity of the AI model is measured by using the quantity of AI units occupied by the AI model. Each AI unit is used for indicating N1 computing resource units. Therefore, the computation complexity of the AI model may be represented by using N2 computing resource units.

The quantity of AI units occupied by the AI model is obtained in any one of the following manners:

Manner 1: Divide N2 by N1 in a case that M is a decimal, to obtain the quantity of AI units occupied by the AI model.

For example, one AI unit is used for indicating 4 TOPs, and computation complexity of one AI model is 15 TOPs. Therefore, AI units occupied by the AI model are 15 TOPs divided by 4 TOPs. To be specific, the AI model occupies 3.75 AI units.

Manner 2: Divide N2 by N1 in a case that M is an integer, and rounding up or approximately rounding an obtained quotient, to obtain the quantity of AI units occupied by the AI model.

For example, one AI unit is used for indicating 10 TOPs, and computation complexity of one AI model is 23 TOPs. Therefore, AI units occupied by the AI model are 23 TOPs divided by 10 TOPs. Then, an obtained quotient is rounded up. To be specific, the AI model occupies 3 AI units. Alternatively, the obtained quotient is approximately rounded. To be specific, the AI model occupies 2 AI units.

In the foregoing implementation, the computation complexity of the AI model is represented by using the quantity of AI units occupied by the AI model, so that the terminal may accurately send, based on the quantity of AI units, current remaining AI model computing resources available for AI model-related operations to the network-side device, and the network-side device obtains an accurate remaining computing power of the terminal.

Optionally, that the terminal sends the first AI computing power information to a network-side device may be specifically implemented by using the following steps.

The terminal sends the first AI computing power information to the network-side device in a process of reporting AI capability information of the terminal to the network-side device.

To be specific, when reporting an AI capability of the terminal to the network-side device, the terminal reports/carries a total AI unit (computing power unit) of the terminal.

Optionally, the AI model computing resource is used for at least one of the following AI model-related operations:
a) AI model-based signal processing.

Specifically, the AI model-based signal processing includes signal detection, filtering, equalization, and the like. Signals include a Demodulation Reference Signal (DMRS), a Sounding Reference Signal (SRS), a synchronization signal block (Synchronization Signal Block, SSB), a Tracking Reference Signal (TRS), a Phase-Tracking Reference Signal (PTRS), a Channel State Information-Reference Signal (CSI-RS), and the like.
b) AI model-based signal transmission/receiving/demodulation/sending.

Specifically, a channel included in signal transmission/receiving/demodulation/sending may be, for example: a Physical downlink control channel (PDCCH), a Physical downlink shared channel (PDSCH), a Physical Uplink Control Channel (PUCCH), a Physical Uplink Shared Channel (PUSCH), a Physical Random Access Channel (PRACH), a Physical broadcast channel (PBCH), or the like.
c) AI model-based channel state information obtaining, including:
feedback of channel state information, including channel-related information, channel matrix-related information, channel feature information, channel matrix feature information, a Precoding matrix indicator (PMI), a Rank indicator (RI), a CSI-RS Resource Indicator (CRI), a channel quality indicator (CQI), a Layer Indicator (LI), and the like.

FDD uplink and downlink have partial reciprocity. For a Frequency Division Duplexing (FDD) system, according to the partial reciprocity, a base station obtains angle information and delay information according to an uplink channel, and may notify a UE of the angle information and the delay information by using a CSI-RS precoding or direct indication method. The UE performs reporting according to an indication of the base station or performs selection and reporting within an indication range of the base station, thereby reducing a computation amount of the UE and overheads of CSI reporting.
d) AI model-based beam management, including: beam measurement, beam reporting, beam prediction, beam failure detection, beam failure recovery, and a new beam indication in beam failure recovery.
e) AI model-based channel prediction, including prediction of channel state information and beam prediction.
f) AI model-based interference suppression, including intra-cell interference, inter-cell interference, out-of-band interference, cross interference, and the like.
g) AI model-based positioning.

For example, a specific position (including a horizontal position and or a vertical position) or a possible future trajectory of the UE, or information assisting in position estimation or trajectory estimation is estimated by using a reference signal (for example, an SRS).
h) AI model-based high-layer service and parameter prediction and management, including throughput, a required packet size, a service requirement, a moving speed, noise information, and the like.
i) AI model-based control signaling parsing, for example, signaling related to power control, or signaling related to beam management.

FIG. 5 is a schematic flowchart 2 of an AI computing power reporting method according to an embodiment of this application. As shown in FIG. 5, the method includes step 501 to step 502.

Step 501: A network-side device receives first AI computing power information sent by a terminal. The first AI computing power information is used for indicating at least one of the following: current remaining AI model computing resources of the terminal; current available AI model computing resources of the terminal; all AI model computing resources of the terminal; or all AI model computing resources of the terminal available for wireless communication.

It should be noted that this embodiment of this application may be applied to an AI model-based communication scenario. The terminal includes but is not limited to the types of the terminal 11 listed above. The network-side device includes but not limited to the types of the network-side device 12 listed above. This is not limited in this application.

Because the network-side device cannot accurately estimate a remaining AI computing power of the terminal, utilization of the AI computing power of the terminal is relatively low, and performance of a communication system is affected. Therefore, to improve utilization of an AI computing power of the terminal and improve performance of a communication system, in this embodiment, the network-side device needs to receive first AI computing power information sent by the terminal.

Optionally, the first AI computing power information includes M AI units (computing power units), where M is an integer or a decimal. Each AI unit is used for indicating N1 computing resource units, where N1 is a positive integer or a decimal.

The AI unit (computing power unit) is a unit measuring an AI model computing resource. The AI model computing resource is, for example, operations of the AI model.

Optionally, the computing resource unit includes at least one of the following:
a) operations;
b) trillion operations;
c) floating point operations;
d) memory access costs; or
c) multiply-accumulate operations.

Optionally, a definition of the AI unit satisfies at least one of the following:
a) agreed on in a protocol;
b) defined by the terminal; or
c) configured by the network-side device.

The definition of the AI unit includes: a value of N1, and/or, a type of the computing resource unit.

Step 502: The network-side device obtains, based on the first AI computing power information, second AI computing power information corresponding to the terminal. The second AI computing power information is used for indicating remaining AI model computing resources, estimated by the network-side device, of the terminal.

In this embodiment, based on the first AI computing power information sent by the terminal, the network-side device may estimate, in real time, the remaining AI model computing resources of the terminal, so as to issue the remaining AI model computing resources of the terminal to the terminal, or indicate an appropriate first AI model to the terminal.

In the AI computing power reporting method provided in this embodiment of this application, a network-side device receives first AI computing power information sent by a terminal, so that the network-side device obtains an accurate terminal remaining computing power. Therefore, the network-side device may perform AI configuration or indication based on the accurate terminal remaining computing power, thereby improving utilization of an AI computing power of the terminal and improving performance of a communication system.

Optionally, a quantity of AI units occupied by an AI model is included in model configuration information or association information of the AI model. The quantity of AI units occupied by the AI model is obtained by converting computation complexity of the AI model.

In this embodiment, during AI model registration, AI model configuration, AI model transmission, and AI model transfer, a quantity of AI units occupied by an AI model is included in model configuration information or association information of the AI model. The quantity of AI units occupied by the AI model is obtained by converting computation complexity of the AI model.

Optionally, the computation complexity of the AI model is N2 computing resource units, where N2 is a positive integer or a decimal.

The quantity of AI units occupied by the AI model is obtained in any one of the following manners:

Manner 1: Divide N2 by N1 in a case that M is a decimal, to obtain the quantity of AI units occupied by the AI model.

Manner 2: Divide N2 by N1 in a case that M is an integer, and rounding up or approximately rounding an obtained quotient, to obtain the quantity of AI units occupied by the AI model.

Optionally, after obtaining the second AI computing power information corresponding to the terminal, the network-side device further needs to configure or indicate a first AI model to the terminal based on the remaining AI model computing resources of the terminal, to improve utilization of the AI computing power of the terminal. This may be specifically implemented in any one of the following manners:

Manner 1: The network-side device issues, in a case that a quantity of AI units occupied by a first AI model is less than or not greater than the second AI computing power information, the first AI model to the terminal.

Specifically, complexity of the first AI model issued by the network-side device to the terminal cannot be greater than or cannot be greater than or equal to a current idle AI unit (namely, the second AI computing power information) of the terminal.

For example, the remaining AI model computing resources of the terminal estimated by the network-side device are 5 AI units. Therefore, the quantity of AI units occupied by the first AI model issued by the network-side device to the terminal is required to be less than 5.

Manner 2: The network-side device instructs, in a case that a quantity of AI units occupied by a first AI model is less than or not greater than the second AI computing power information, the terminal to activate the first AI model.

Specifically, the network-side device may send indication information to the terminal, so that the terminal activates the first AI model. It may be understood that the complexity of the first AI model indicated by the network-side device to the terminal cannot be greater than or cannot be greater than or equal to the current idle AI unit (namely, the second AI computing power information) of the terminal.

For example, the remaining AI model computing resources of the terminal estimated by the network-side device are 5 AI units. Therefore, the quantity of AI units occupied by the first AI model indicated by the network-side device to the terminal is required to be less than 5.

Manner 3: The network-side device instructs, in a case that a first difference between a quantity of AI units occupied by a first AI model and a quantity of AI units occupied by a second AI model is less than or not greater than the second AI computing power information, the terminal to deactivate the second AI model and to activate the first AI model.

Specifically, in a case that the network-side device instructs the terminal to switch from the second AI model to the first AI model (to be specific, the network-side device instructs the terminal to deactivate the currently used first AI model and to activate the second AI model), the complexity by which the first AI model exceeds the second AI model cannot be greater than or equal to the current idle AI unit (namely, the second AI computing power information) of the terminal.

It may be understood that if the complexity of the first AI model is lower than that of the currently used second AI model, the network-side device may directly instruct the terminal to deactivate the second AI model and to activate the first AI model.

In the foregoing implementation, the network-side device may accurately configure or indicate an AI model based on the remaining AI model computing resources (namely, the second AI computing power information) of the terminal, so that the utilization of the AI computing power of the terminal can be improved, and the performance of the communication system can be improved.

Optionally, after issuing the first AI model to the terminal, the network-side device further needs to update the second AI computing power information. This may be specifically implemented by using the following steps.

The network-side device subtracts the quantity of AI units occupied by the first AI model from the second AI computing power information, to obtain updated second AI computing power information.

For example, the remaining AI model computing resources of the terminal estimated by the network-side device are 5 AI units, and the first AI model occupies 2 AI units. Therefore, the updated second AI computing power information is 3 AI units.

Optionally, after instructing the terminal to activate the first AI model, the network-side device further needs to update the second AI computing power information. This may be specifically implemented by using the following steps.

The network-side device subtracts the quantity of AI units occupied by the first AI model from the second AI computing power information, to obtain updated second AI computing power information.

Optionally, after instructing the terminal to deactivate the second AI model and to activate the first AI model, the network-side device further needs to update the second AI computing power information. This may be specifically implemented by using the following steps.

The network-side device computes a first difference between the quantity of AI units occupied by the first AI model and the quantity of AI units occupied by the second AI model. The first difference is subtracted from the second AI computing power information, to obtain updated second AI computing power information.

It should be noted that the first difference may be a negative number. For example, the remaining AI model computing resources of the terminal estimated by the network-side device are 5 AI units, the first AI model occupies 2 AI units, the second AI model occupies 3 AI units, the first difference is-1 AI unit, and the updated second AI computing power information is 6 AI units.

Optionally, in a case that the network-side device instructs the terminal to deactivate a third AI model, the network-side device adds a quantity of AI units occupied by the third AI model to the second AI computing power information, to obtain updated second AI computing power information.

For example, the remaining AI model computing resources of the terminal estimated by the network-side device are 5 AI units, and the third AI model occupies 2 AI units. In a case that the network-side device instructs the terminal to deactivate the third AI model, the updated second AI computing power information is 7 AI units.

In the foregoing implementation, the network-side device may update the second AI computing power information in real time, so that the network-side device may further perform AI configuration or indication based on an accurate remaining computing power of the terminal, thereby improving the utilization of the AI computing power of the terminal and improving the performance of the communication system.

Optionally, the AI model computing resource is used for at least one of the following AI model-related operations:
a) AI model-based signal processing;
b) AI model-based signal transmission/receiving/demodulation/sending;
c) AI model-based channel state information obtaining;
d) AI model-based beam management;
e) AI model-based channel prediction;
f) AI model-based interference suppression;
g) AI model-based positioning;
h) AI model-based high-layer service and parameter prediction and management; or
i) AI model-based control signaling parsing.

FIG. 6 is a schematic diagram of signaling interaction of an AI computing power reporting method according to an embodiment of this application. As shown in FIG. 6, the method specifically includes step 1 to step 7.

Step 1: A terminal obtains first AI computing power information.

Specifically, the first AI computing power information includes M AI units (computing power units), where M is an integer or a decimal. Each AI unit is used for indicating N1 computing resource units, where N1 is a positive integer or a decimal.

The computing resource unit includes at least one of the following: a) operations; b) trillion operations; c) floating point operations; d) memory access costs; or e) multiply-accumulate operations.

A definition of the AI unit satisfies at least one of the following: a) agreed on in a protocol; b) defined by the terminal; or c) configured by the network-side device.

Step 2: The terminal sends AI capability information of the terminal to a network-side device, where the AI capability information of the terminal includes the first AI computing power information.

Step 3: The network-side device obtains, based on the first AI computing power information, second AI computing power information corresponding to the terminal.

Specifically, the second AI computing power information is used for indicating remaining AI model computing resources, estimated by the network-side device, of the terminal.

It should be noted that after step 3 is completed, at least one of step 4 to step 6 starts to be performed.

Step 4: The network-side device issues a first AI model to the terminal.

Specifically, the network-side device issues, in a case that a quantity of AI units occupied by a first AI model is less than or not greater than the second AI computing power information, the first AI model to the terminal.

Step 5: The network-side device sends first indication information to the terminal. The first indication information is used for indicating the first AI model.

Specifically, the network-side device instructs, in a case that a quantity of AI units occupied by a first AI model is less than or not greater than the second AI computing power information, the terminal to activate the first AI model.

Step 6: The network-side device sends second indication information to the terminal. The second indication information is used for instructing the terminal to deactivate a second AI model and to activate the first AI model.

Specifically, the network-side device instructs, in a case that a first difference between a quantity of AI units occupied by a first AI model and a quantity of AI units occupied by a second AI model is less than or not greater than the second AI computing power information, the terminal to deactivate the second AI model and to activate the first AI model.

Step 7: The network-side device updates the second AI computing power information, to obtain updated second AI computing power information.

Specifically, in a case that step 4 is completed, the network-side device needs to subtract the quantity of AI units occupied by the first AI model from the second AI computing power information, to obtain updated second AI computing power information.

In a case that step 5 is completed, the network-side device needs to subtract the quantity of AI units occupied by the first AI model from the second AI computing power information, to obtain updated second AI computing power information.

In a case that step 6 is completed, the network-side device needs to compute a first difference between the quantity of AI units occupied by the first AI model and the quantity of AI units occupied by the second AI model. Then, the first difference is subtracted from the second AI computing power information, to obtain updated second AI computing power information.

In a case that the network-side device instructs the terminal to deactivate a third AI model, the network-side device adds a quantity of AI units occupied by the third AI model to the second AI computing power information, to obtain updated second AI computing power information.

An executive body of the AI computing power reporting method provided in this embodiment of this application may be an AI computing power reporting apparatus. An AI computing power reporting apparatus provided in an embodiment of this application is described in an embodiment of this application by using an example in which the AI computing power reporting apparatus performs an AI computing power reporting method.

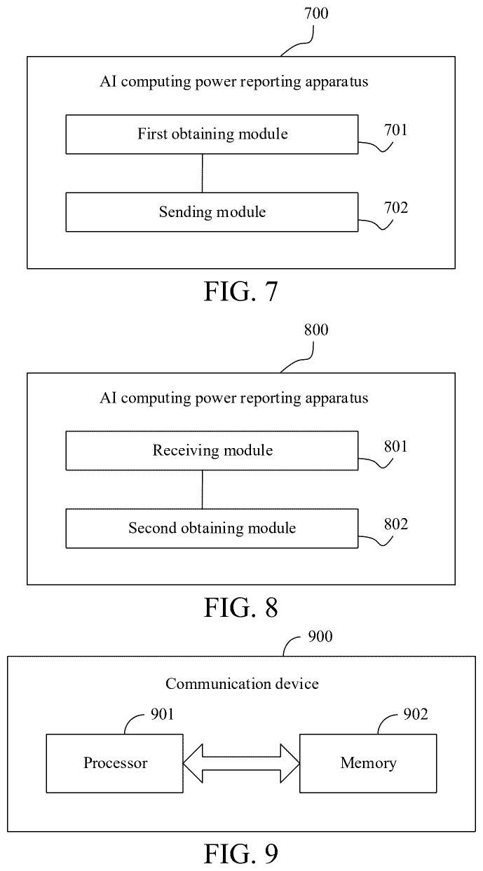

FIG. 7 is a schematic diagram 1 of a structure of an AI computing power reporting apparatus according to an embodiment of this application. As shown in FIG. 7, an AI computing power reporting apparatus 700 is applied to a terminal, and includes:

a first obtaining module 701, configured to obtain first AI computing power information; and

a sending module 702, configured to send the first AI computing power information to a network-side device.

The first AI computing power information is used for indicating at least one of the following:
current remaining AI model computing resources of the terminal;
current available AI model computing resources of the terminal;
all AI model computing resources of the terminal; or
all AI model computing resources of the terminal available for wireless communication.

In the AI computing power reporting apparatus provided in this embodiment of this application, current remaining AI model computing resources available for AI model-related operations, namely first AI computing power information, are obtained. Then, the first AI computing power information of a terminal is reported to a network-side device, so that the network-side device obtains an accurate terminal remaining computing power. Therefore, the network-side device may perform AI configuration or indication based on the accurate terminal remaining computing power, thereby improving utilization of an AI computing power of the terminal and improving performance of a communication system.

Optionally, the first AI computing power information includes M AI units (computing power units), where M is an integer or a decimal. Each AI unit is used for indicating N1 computing resource units, where N1 is a positive integer or a decimal.

Optionally, the computing resource unit includes at least one of the following:
operations;
trillion operations;
floating point operations;
memory access costs; or
multiply-accumulate operations.

Optionally, a definition of the AI unit satisfies at least one of the following: agreed on in a protocol; defined by the terminal; or configured by the network-side device.

Optionally, a quantity of AI units occupied by an AI model is included in model configuration information or association information of the AI model. The quantity of AI units occupied by the AI model is obtained by converting computation complexity of the AI model.

Optionally, the computation complexity of the AI model is N2 computing resource units, where N2 is a positive integer or a decimal.

The quantity of AI units occupied by the AI model is obtained in any one of the following manners:
dividing N2 by N1 in a case that M is a decimal, to obtain the quantity of AI units occupied by the AI model; or
dividing N2 by N1 in a case that M is an integer, and rounding up or approximately rounding an obtained quotient, to obtain the quantity of AI units occupied by the AI model.

Optionally, the first obtaining module 701 is further configured to perform any one of the following:
determining the first AI computing power information based on terminal configuration information; or
determining the first AI computing power information based on terminal configuration information and occupied AI computing power information.

Optionally, the sending module 702 is further configured to:

send the first AI computing power information to the network-side device in a process of reporting AI capability information of the terminal to the network-side device.

Optionally, the AI model computing resource is used for at least one of the following AI model-related operations:
AI model-based signal processing;
AI model-based signal transmission/receiving/demodulation/sending;
AI model-based channel state information obtaining;
AI model-based beam management;
AI model-based channel prediction;
AI model-based interference suppression;
AI model-based positioning;
AI model-based high-layer service and parameter prediction and management; or
AI model-based control signaling parsing.

FIG. 8 is a schematic diagram 2 of a structure of an AI computing power reporting apparatus according to an embodiment of this application. As shown in FIG. 8, an AI computing power reporting apparatus 800 is applied to a network-side device, and includes:
a receiving module 801, configured to receive first AI computing power information sent by a terminal; and
a second obtaining module 802, configured to obtain, based on the first AI computing power information, second AI computing power information corresponding to the terminal. The second AI computing power information is used for indicating remaining AI model computing resources, estimated by the network-side device, of the terminal.

The first AI computing power information is used for indicating at least one of the following:
current remaining AI model computing resources of the terminal;
current available AI model computing resources of the terminal;
all AI model computing resources of the terminal; or
all AI model computing resources of the terminal available for wireless communication.

In the AI computing power reporting apparatus provided in this embodiment of this application, first AI computing power information sent by a terminal is received, so that a network-side device obtains an accurate terminal remaining computing power. Therefore, the network-side device may perform AI configuration or indication based on the accurate terminal remaining computing power, thereby improving utilization of an AI computing power of the terminal and improving performance of a communication system.

Optionally, the first AI computing power information includes M AI units (computing power units), where M is an integer or a decimal. Each AI unit is used for indicating N1 computing resource units, where N1 is a positive integer or a decimal.

Optionally, the computing resource unit includes at least one of the following:
operations;
trillion operations;
floating point operations;
memory access costs; or
multiply-accumulate operations.

Optionally, a definition of the AI unit satisfies at least one of the following: agreed on in a protocol; defined by the terminal; or configured by the network-side device.

Optionally, a quantity of AI units occupied by an AI model is included in model configuration information or association information of the AI model. The quantity of AI units occupied by the AI model is obtained by converting computation complexity of the AI model.

Optionally, the computation complexity of the AI model is N2 computing resource units, where N2 is a positive integer or a decimal.

The quantity of AI units occupied by the AI model is obtained in any one of the following manners:
dividing N2 by N1 in a case that M is a decimal, to obtain the quantity of AI units occupied by the AI model; or
dividing N2 by N1 in a case that M is an integer, and rounding up or approximately rounding an obtained quotient, to obtain the quantity of AI units occupied by the AI model.

Optionally, the apparatus further includes at least one of the following:
an issuing module, configured to issue, in a case that a quantity of AI units occupied by a first AI model is less than or not greater than the second AI computing power information, the first AI model to the terminal;
a first instruction module, configured to instruct, in a case that a quantity of AI units occupied by a first AI model is less than or not greater than the second AI computing power information, the terminal to activate the first AI model; or
a second instruction module, configured to instruct, in a case that a first difference between a quantity of AI units occupied by a first AI model and a quantity of AI units occupied by a second AI model is less than or not greater than the second AI computing power information, the terminal to deactivate the second AI model and to activate the first AI model.

Optionally, after issuing the first AI model to the terminal, the apparatus further includes:
a first update module, configured to subtract the quantity of AI units occupied by the first AI model from the second AI computing power information, to obtain updated second AI computing power information.

Optionally, after instructing the terminal to activate the first AI model, the apparatus further includes:
a second update module, configured to subtract the quantity of AI units occupied by the first AI model from the second AI computing power information, to obtain updated second AI computing power information.

Optionally, after instructing the terminal to deactivate the second AI model and to activate the first AI model, the apparatus further includes:
a third update module, configured to: compute a first difference between the quantity of AI units occupied by the first AI model and the quantity of AI units occupied by the second AI model; and subtract the first difference from the second AI computing power information, to obtain updated second AI computing power information.

Optionally, the apparatus further includes:
a third instruction module, configured to instruct the terminal to deactivate a third AI model; and
a fourth update module, configured to add a quantity of AI units occupied by the third AI model to the second AI computing power information, to obtain updated second AI computing power information.

Optionally, the AI model computing resource is used for at least one of the following AI model-related operations:
AI model-based signal processing;
AI model-based signal transmission/receiving/demodulation/sending;
AI model-based channel state information obtaining;
AI model-based beam management;
AI model-based channel prediction;
AI model-based interference suppression;
AI model-based positioning;
AI model-based high-layer service and parameter prediction and management; or
AI model-based control signaling parsing.

The AI computing power reporting apparatus in this embodiment of this application may be an electronic device, for example, an electronic device with an operating system, or may be a component in the electronic device, for example, an integrated circuit or a chip. The electronic device may be a terminal, or may be another device other than a terminal. For example, the terminal may include, but is not limited to, types of the terminal 11 listed above. The another device may be a server, a Network Attached Storage (NAS), or the like. This is not specifically limited in this embodiment of this application.

The AI computing power reporting apparatus provided in this embodiment of this application can implement processes implemented in the method embodiments of FIG. 4 to FIG. 5, and the same technical effect is achieved. To avoid repetition, details are not described herein.

FIG. 9 is a schematic diagram of a structure of a communication device according to an embodiment of this application. As shown in FIG. 9, a communication device 900 includes a processor 901 and a memory 902. The memory 902 has a program or instruction executable on the processor 901 therein. For example, if the communication device 900 is a terminal, the program or instruction, when executed by the processor 901, implements the steps in the foregoing AI computing power reporting method embodiment, and the same technical effect can be achieved. If the communication device 900 is a network-side device, the program or instruction, when executed by the processor 901, implements the steps of the foregoing AI computing power reporting method embodiment, and the same technical effect can be achieved. To avoid repetition, details are not described herein.

An embodiment of this application further provides a terminal, including a processor and a communication interface. The processor is configured to obtain first AI computing power information. The communication interface is configured to send the first AI computing power information to a network-side device. The first AI computing power information is used for indicating at least one of the following: current remaining AI model computing resources of the terminal; current available AI model computing resources of the terminal; all AI model computing resources of the terminal; or all AI model computing resources of the terminal available for wireless communication. The terminal embodiment corresponds to the foregoing method embodiment on a terminal side. Implementation processes and implementations of the foregoing method embodiment all may be applied to the terminal embodiment, and the same technical effect can be achieved.

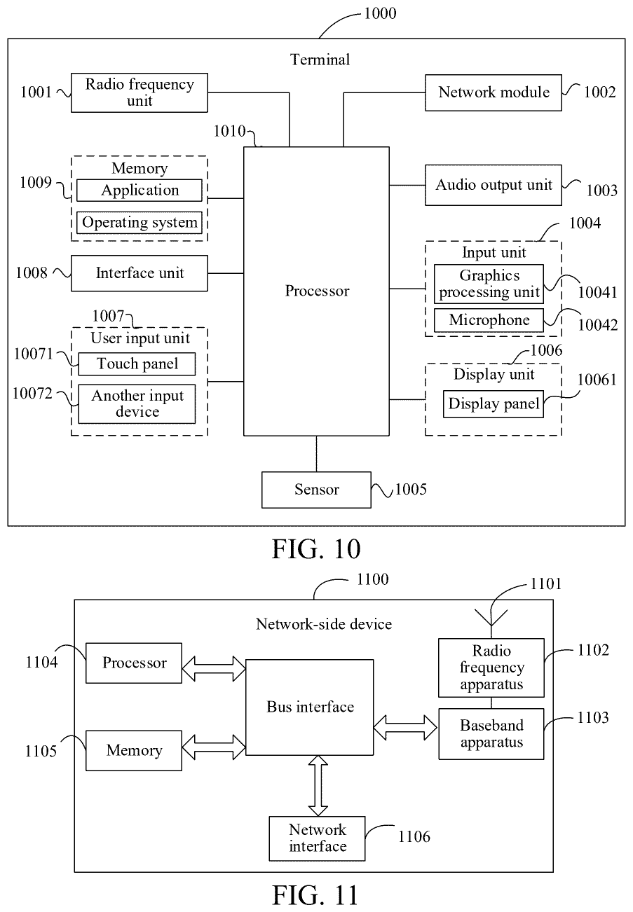

FIG. 10 is a schematic diagram of a structure of a terminal according to an embodiment of this application. As shown in FIG. 10, the terminal 1000 includes but is not limited to: at least some components in a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include a power supply (such as a battery) that supplies power to the components. The power supply may be logically connected to the processor 1010 through a power management system, thereby implementing functions such as management of charging, discharging, and power consumption through the power management system. The terminal structure shown in FIG. 10 constitutes no limitation on the terminal. The terminal may include more or fewer components than those shown in the figure, or some merged components, or different component arrangements. Details are not described herein.

It will be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061. The display panel 10061 may be configured by using a liquid crystal display, an organic light-emitting diode, or the like. The user input unit 1007 includes at least one of a touch panel 10071 or another input device 10072. The touch panel 10071 is also referred to as a touchscreen. The touch panel 10071 may include two parts: a touch detection apparatus and a touch controller. The another input device 10072 may include, but is not limited to, a physical keyboard, a functional key (such as a volume control key or a switch key), a track ball, a mouse, and a joystick. Details are not described herein again.

In this embodiment of this application, the radio frequency unit 1001 receives downlink data from a network-side device, and then may transmit the downlink data to the processor 1010 for processing. In addition, the radio frequency unit 1001 may send uplink data to the network-side device. Generally, the radio frequency unit 1001 includes, but is not limited to, an antenna, an amplifier, a transceiver, a coupler, a low noise amplifier, a duplexer, and the like.

The memory 1009 may be configured to store a software program or instruction and various data. The memory 1009 may include mainly a first storage area for storing a program or instruction and a second storage area for storing data. The first storage area may store an operating system, an application or instruction required for at least one function (such as a sound playback function and an image playback function), and the like. Furthermore, the memory 1009 may include a volatile memory or a non-volatile memory, or the memory 1009 may include both a volatile memory and a non-volatile memory. The non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct rambus dynamic random access memory (Direct Rambus RAM, DRRAM). The memory x09 in this embodiment of this application includes, but is not limited to, these memories and any other suitable types of memories.

The processor 1010 may include one or more processing units. Optionally, the processor x10 integrates an application processor and a modem processor, where the application processor mainly processes operations relating to an operating system, a user interface, an application, and the like, and the modem processor, such as a baseband processor, mainly processes a wireless communication signal. It may be understood that the foregoing modem may not be integrated into the processor 1010.

An embodiment of this application further provides a network-side device, including a processor and a communication interface. The communication interface is configured to receive first AI computing power information sent by a terminal. The processor is configured to obtain, based on the first AI computing power information, second AI computing power information corresponding to the terminal. The second AI computing power information is used for indicating remaining AI model computing resources, estimated by the network-side device, of the terminal. The first AI computing power information is used for indicating at least one of the following: current remaining AI model computing resources of the terminal; current available AI model computing resources of the terminal; all AI model computing resources of the terminal; or all AI model computing resources of the terminal available for wireless communication. The network-side device embodiment corresponds to the foregoing method embodiment applied to a network-side device. Implementation processes and implementations of the foregoing method embodiment all may be applied to the network-side device embodiment, and the same technical effect can be achieved.

FIG. 11 is a schematic diagram of a structure of a network-side device according to an embodiment of this application. As shown in FIG. 11, a network-side device 1100 includes: an antenna 1101, a radio frequency apparatus 1102, a baseband apparatus 1103, a processor 1104, and a memory 1105. The antenna 1101 is connected to the radio frequency apparatus 1102. In an uplink direction, the radio frequency apparatus 1102 receives information through the antenna 1101, and sends the received information to the baseband apparatus 1103 for processing. In a downlink direction, the baseband apparatus 1103 processes to-be-sent information, and sends the information to the radio frequency apparatus 1102. The radio frequency apparatus 1102 processes the received information, and sends the information via the antenna 1101.

The method performed by the network-side device in the foregoing embodiment may be implemented in the baseband apparatus 1103. The baseband apparatus 1103 includes a baseband processor.

The baseband apparatus 1103 may include, for example, at least one baseband board. A plurality of chips are disposed on the baseband board. As shown in FIG. 11, one of the chips is, for example, the baseband processor, which is connected to the memory 1105 through a bus interface to invoke a program in the memory 1105 to execute the network device operations shown in the foregoing method embodiment.

The network-side device may further include a network interface 1106. The interface is, for example, a common public radio interface (CPRI).

Specifically, the network-side device 1100 in this embodiment of the present disclosure further includes: an instruction or program stored in the memory 1105 and executable on the processor 1104. The processor 1104 invokes the instruction or program in the memory 1105 to perform the foregoing AI computing power reporting method, and the same technical effect is achieved. To avoid repetition, details are not described herein again.

An embodiment of this application further provides an AI computing power reporting system, including: a terminal and a network-side device. The terminal may be configured to perform the steps of the AI computing power reporting method shown in FIG. 4. The network-side device may be configured to perform the steps of the AI computing power reporting method shown in FIG. 5.

An embodiment of this application further provides a readable storage medium. The readable storage medium may be volatile or non-volatile. The readable storage medium has a program or instruction stored therein. The program or instruction, when executed by a processor, implements the processes of the foregoing AI computing power reporting method embodiment, and the same technical effect is achieved. To avoid repetition, details are not described herein again.

The processor is a processor of the terminal in the foregoing embodiment. The readable storage medium includes a computer-readable storage medium, such as a computer read-only memory ROM, a random access memory RAM, a magnetic disc, an optical disc, or the like.

An embodiment of this application further provides a chip. The chip includes a processor and a communication interface. The communication interface is coupled to the processor. The processor is configured to execute a program or instruction, to implement the processes of the foregoing AI computing power reporting method embodiment, and the same technical effect is achieved. To avoid repetition, details are not described herein again.

It will be understood that the chip mentioned in this embodiment of this application may alternatively be referred to as a system on a chip, a system chip, a chip system, a system-on-chip, or the like.

An embodiment of this application further provides a computer program/program product. The computer program/program product is stored in a storage medium. The computer program/program product, when executed by at least one processor, implements the processes of the foregoing AI computing power reporting method embodiment, and the same technical effect is achieved. To avoid repetition, details are not described herein again.

It should be noted that the terms “include”, “comprise”, or any other variation thereof herein is intended to cover a non-exclusive inclusion, so that a process, method, article, or apparatus including a series of elements not only includes those elements but also includes other elements which are not clearly listed or further includes intrinsic elements of the process, method, article, or apparatus. Without more limitations, an element defined by a sentence “including one” does not exclude a case that there are still other same elements in the process, method, article, or apparatus that includes the element. Furthermore, it should be pointed out that the range of the method and apparatus in the implementations of this application is not limited to execution of functions in order shown or discussed, and may further include execution of functions involved in a substantially simultaneous manner or in reverse order. For example, the described method may be performed in order different from that described, and various steps may be added, omitted, or combined. In addition, features described with reference to some examples may be combined in other examples.

According to the descriptions in the foregoing implementations, a person skilled in the art may clearly learn that the method according to the foregoing embodiment may be implemented by relying on software and a commodity hardware platform, which can be preferable in many cases, or by using hardware. Based on such an understanding, the technical solutions of this application essentially, or a part contributing to the prior art, may be presented in a form of a computer software product. The computer software product is stored in a storage medium (for example, a ROM/RAM, a magnetic disk, or an optical disc) including several instructions to enable a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations. The foregoing specific implementations are merely illustrative rather than restrictive. Inspired by this application, those of ordinary skill in the art may still make multiple forms without departing from the essence of this application and the scope of protection of the claims, which all fall within the protection of this application.

What is claimed is:

1. An artificial intelligence (AI) computing power reporting method, comprising:
obtaining, by a terminal, first AI computing power information; and
sending, by the terminal, the first AI computing power information to a network-side device,
wherein the first AI computing power information is used for indicating at least one of the following:
current remaining AI model computing resources of the terminal;
current available AI model computing resources of the terminal;
all AI model computing resources of the terminal; or
all AI model computing resources of the terminal available for wireless communication.

2. The AI computing power reporting method according to claim 1, wherein the first AI computing power information comprises M AI units, M being an integer or a decimal;
and each AI unit is used for indicating N1 computing resource units, N1 being a positive integer or a decimal.

3. The AI computing power reporting method according to claim 2, wherein the computing resource unit comprises at least one of the following:
operations;
trillion operations;
floating point operations;
memory access costs; or
multiply-accumulate operations.

4. The AI computing power reporting method according to claim 2, wherein a definition of the AI unit satisfies at least one of the following: agreed on in a protocol; defined by the terminal; or configured by the network-side device.

5. The AI computing power reporting method according to claim 2, wherein a quantity of AI units occupied by an AI model is comprised in model configuration information or association information of the AI model; and the quantity of AI units occupied by the AI model is obtained by converting computation complexity of the AI model.

6. The AI computing power reporting method according to claim 5, wherein the computation complexity of the AI model is N2 computing resource units, N2 being a positive integer or a decimal;
the quantity of AI units occupied by the AI model is obtained in any one of the following manners:
dividing N2 by N1 in a case that M is a decimal, to obtain the quantity of AI units occupied by the AI model; or
dividing N2 by N1 in a case that M is an integer, and rounding up or approximately rounding an obtained quotient, to obtain the quantity of AI units occupied by the AI model.

7. The AI computing power reporting method according to claim 1, wherein the obtaining, by a terminal, first AI computing power information comprises any one of the following:
determining, by the terminal, the first AI computing power information based on terminal configuration information; or
determining, by the terminal, the first AI computing power information based on terminal configuration information and occupied AI computing power information.

8. The AI computing power reporting method according to claim 1, wherein the sending, by the terminal, the first AI computing power information to a network-side device comprises:
sending, by the terminal, the first AI computing power information to the network-side device in a process of reporting AI capability information of the terminal to the network-side device.

9. The AI computing power reporting method according to claim 1, wherein the AI model computing resource is used for at least one of the following AI model-related operations:
AI model-based signal processing;
AI model-based signal transmission/receiving/demodulation/sending;
AI model-based channel state information obtaining;
AI model-based beam management;
AI model-based channel prediction;
AI model-based interference suppression;
AI model-based positioning;
AI model-based high-layer service and parameter prediction and management; or
AI model-based control signaling parsing.

10. An artificial intelligence AI computing power reporting method, comprising:
receiving, by a network-side device, first AI computing power information sent by a terminal; and
obtaining, by the network-side device based on the first AI computing power information, second AI computing power information corresponding to the terminal, the second AI computing power information being used for indicating remaining AI model computing resources, estimated by the network-side device, of the terminal,
wherein the first AI computing power information is used for indicating at least one of the following:
current remaining AI model computing resources of the terminal;
current available AI model computing resources of the terminal;
all AI model computing resources of the terminal; or
all AI model computing resources of the terminal available for wireless communication.

11. The AI computing power reporting method according to claim 10, wherein the first AI computing power information comprises M AI units, M being an integer or a decimal; and each AI unit is used for indicating N1 computing resource units, N1 being a positive integer or a decimal.

12. The AI computing power reporting method according to claim 11, wherein the computing resource unit comprises at least one of the following:
operations;
trillion operations;
floating point operations;
memory access costs; or
multiply-accumulate operations.

13. The AI computing power reporting method according to claim 11, wherein a definition of the AI unit satisfies at least one of the following: agreed on in a protocol; defined by the terminal; or configured by the network-side device.

14. The AI computing power reporting method according to claim 11, wherein a quantity of AI units occupied by an AI model is comprised in model configuration information or association information of the AI model; and the quantity of AI units occupied by the AI model is obtained by converting computation complexity of the AI model.

15. The AI computing power reporting method according to claim 14, wherein the computation complexity of the AI model is N2 computing resource units, N2 being a positive integer or a decimal;
the quantity of AI units occupied by the AI model is obtained in any one of the following manners:
dividing N2 by N1 in a case that M is a decimal, to obtain the quantity of AI units occupied by the AI model; or
dividing N2 by N1 in a case that M is an integer, and rounding up or approximately rounding an obtained quotient, to obtain the quantity of AI units occupied by the AI model.

16. The AI computing power reporting method according to claim 10, further comprising at least one of the following:
issuing, by the network-side device in a case that a quantity of AI units occupied by a first AI model is less than or not greater than the second AI computing power information, the first AI model to the terminal;
instructing, by the network-side device in a case that a quantity of AI units occupied by a first AI model is less than or not greater than the second AI computing power information, the terminal to activate the first AI model; or
instructing, by the network-side device in a case that a first difference between a quantity of AI units occupied by a first AI model and a quantity of AI units occupied by a second AI model is less than or not greater than the second AI computing power information, the terminal to deactivate the second AI model and to activate the first AI model.

17. The AI computing power reporting method according to claim 16, wherein the method further comprises at least one of:
after the issuing, by the network-side device, the first AI model to the terminal, subtracting, by the network-side device, the quantity of AI units occupied by the first AI model from the second AI computing power information, to obtain updated second AI computing power information;
after the instructing, by the network-side device, the terminal to activate the first AI model, subtracting, by the network-side device, the quantity of AI units occupied by the first AI model from the second AI computing power information, to obtain updated second AI computing power information; or
after the instructing, by the network-side device, the terminal to deactivate the second AI model and to activate the first AI model, computing, by the network-side device, a first difference between the quantity of AI units occupied by the first AI model and the quantity of AI units occupied by the second AI model; and subtracting the first difference from the second AI computing power information, to obtain updated second AI computing power information.

18. The AI computing power reporting method according to claim 10, further comprising:
instructing, by the network-side device, the terminal to deactivate a third AI model; and
adding, by the network-side device, a quantity of AI units occupied by the third AI model to the second AI computing power information, to obtain updated second AI computing power information.

19. A terminal, comprising at least one hardware processor and a memory, the memory storing a program or instruction executable by the at least one hardware processor that, when executed, directs the at least one hardware processor to implement the AI computing power reporting method according to claim 1.

20. A network-side device, comprising at least one hardware processor and a memory, the memory storing a program or instruction executable by the at least one hardware processor that, when executed, directs the at least one hardware processor to implement the AI computing power reporting method according to claim 10.
